(19) United States
(12) Patent Application Publication
(10) Pub. No.: US 2005/0058818 A1
(43) Pub. Date: Mar. 17, 2005

(54) Laminated composite and process of making same

(76) Inventor: D. David West, Bloomer, WI (US)

Correspondence Address: bourgetlaw.com;Suite 200, 1119 Regis Court, P.O. Box 81, Eau Claire, WI, 54702-0081, US

(21) Appl. No.: 10/938,347

(22) Filed: Sep. 10, 2004

Related U.S. Application Data
(60) Provisional application No. 60/502,575, filed on Sep. 12, 2003.

(51) Int. Cl. B32B 3/02

(52) U.S. Cl. 428/292.1

(57) ABSTRACT

A composite and method for making a composite having fiberglass laminated to a plastic layer, the composite made in accordance with the following steps: extruding plastic through a die to create a heated flat sheet plastic; delivering fiberglass strands to a roll, the roll defining a nip; passing the heated plastic through the nip whereby the strands laminate to the plastic to form the composite.

### CROSS-REFERENCE TO RELATED APPLICATIONS, IF ANY

Applicant claims priority based on Provisional Patent Application No. 60/502,575 filed Sep. 12, 2003.

### FIELD OF THE INVENTION

This invention relates to plastic film/sheet structures, and more particularly to structures of plastic laminated with fiberglass and methods for making the same.

### DESCRIPTION—BACKGROUND OF PRIOR ART

Fiberglass-reinforced plastic sheet materials can be used for a variety of purposes and incorporated into other products. Typically, such materials are created by using an adhesive to adhere fibers to a plastic film, or are otherwise created by using a film re-heating step to adhere the glass fibers to the plastic film. Such techniques for adhering the glass fibers to the plastic are costly. Examples of inventions concerned with production of composite sheet materials, some including the use of chopped fiberglass strands adhered to plastic sheet material, for which patents have been granted are found in the following: Caron et al., U.S. Pat. No. 3,230,287; Thompson et al., U.S. Pat. No. 3,579,623; Degginger et al., U.S. Pat. No. 4,098,943; Kaufmann, U.S. Pat. No. 4,225,374; Riedel et al., U.S. Pat. No. 4,292,360; Hagerman et al., U.S. Pat. No. 4,474,845; Dibuz et al., U.S. Pat. No. 4,894,292; Tamura et al., U.S. Pat. No. 4,973,440; Tsuchiya et al., U.S. Pat. No. 5,001,172; Grimnes, U.S. Pat. No. 5,174,228; Kohl, U.S. Pat. No. 5,788,088; and Lim et al., U.S. Pat. No. 6,410,465B1.

Typically a sheet of plastic is manufactured by an extrusion process, rolled and shipped to another manufacturer for use of the sheet in a subsequent manufacturing. The plastic is unrolled by the subsequent manufacturer, re-heated in an oven, and thereafter treated as desired. Such treatment includes the introduction of fiberglass pieces to the flat sheet of plastic (or laminating a sheet of fiber to the plastic), and then rewinding the product for later use. In other steps, the plastic is unrolled and then treated with an adhesive. The fiberglass is then adhered to flat sheet which contains the adhesive. The sheet is then re-rolled and transported to a subsequent manufacturer. In some applications, the product is again unwound and reheated for subsequent adhering of a scrim layer such as is commonly used in the manufacture of headliner products. Multiple manufacturers or manufacturing operations are often used for accomplishing the variety of steps. Each additional step and/or lamination increases the cost of the products, and carries with it concerns of quality control.

Further, in certain manufacturing operations it is desirable to use a non-porous fiberglass-reinforced plastic sheet. A non-porous film that is highly adherent to polyurethane foam surfaces improves the rigidity of the composite foam structure. Such film is desirable for use in making fiber reinforced molded articles, including automobile headliner products, for instance. If the plastic sheet material is porous, urethane poured on top of the sheet as it sits in a mold will leak, thereby spilling or leaking into the mold where it is heated and results in a mass of waste. The mold thereafter needs to be cleaned prior to accepting a new plastic sheet for the next pour. If the mass is not cleaned from the mold, the next product will not conform to the desired molded shape. Thus, having a 100% non-porous plastic sheet will prevent unwanted leaking of urethane and the accompanying nuisance, expense and delay in scraping or otherwise cleaning the mold. More consistent and cost effective products can thereby be manufactured.

Accordingly, there is a need for fiberglass-reinforced plastic sheet materials that can be manufactured without the use of adhesives to adhere the fiber, or manufactured without the need to re-heat the plastic film layer to adhere the fiber. There is a further need for such fiberglass-reinforced plastic sheet materials that are non-porous.

An object of the present invention, therefore, is to provide a method for laminating plastic and fiberglass.

It is another object of the present invention to provide a method for laminating plastic and fiberglass with single in-line production techniques (single phase), thus avoiding cooling and/or re-heating of the plastic.

It is another object of the present invention to provide a method for laminating plastic and fiberglass without use of adhesive.

It is another object of the present invention to provide a method for laminating plastic and fiberglass strands to form a non-porous film.

It is another object of the present invention to provide a method for laminating fiberglass to a plastic sheet on one side of the plastic sheet and a non-woven scrim to the opposite side of the sheet.

### BRIEF SUMMARY

These and other objects may be accomplished in accordance with the practice of the present invention as follows:

The present invention is directed to a non-porous composite having fiberglass laminated to a plastic layer, the composite made in accordance with the steps of extruding plastic through a die to create a heated flat sheet plastic or plastic mass; delivering fiberglass strands to a roll, the roll defining a nip; and passing the heated plastic through the nip whereby the strands laminate to the plastic to form the composite.

In accordance with another aspect of the present invention, a process of manufacturing a composite having fiberglass laminated to a plastic layer is provided that comprises the unordered steps of extruding plastic through a die to create a heated flat sheet plastic or heated plastic mass, delivering fiberglass strands to a roll, the roll defining a nip, and passing the heated plastic through the nip whereby the strands laminate to the plastic to form the composite. Preferably, the process is completed in-line.

In accordance with other aspects of the present invention, a composite having fiberglass strands and a non-woven scrim laminated to a plastic layer and a method for making it is provided. The composite and method are useful for automobile and truck headliner constructions, for example. The method comprises extruding plastic through an extruder and a die to create a heated extrudate, passing the heated extrudate through a set of chilled rolls forming a nip, and sprinkling fiberglass strands on the chill roll whereby the fiberglass is laminated on a first side of the heated extrudate (at the nip). The method further comprises laminating a non-woven scrim to a second side of the heated extrudate, and cooling the extrudate to form a composite. The composite may sized and wound on a roll.

The present invention also provides a process of manufacturing a composite having a first layer of plastic, a second layer of non-woven scrim laminated to the first layer, and fiberglass strands joined to the first layer opposite the second layer. The process comprises extruding plastic through an extruder and die to create a heated extrudate, passing the heated extrudate through a set of chill rolls forming a nip, sprinkling fiberglass strands on a steel chill roll, laminating the fiberglass strands on a first side of the heated extrudate; and laminating a non-woven scrim to a second side of the heated extrudate. The extrudate may be cooled and wound on a roll. A further aspect of the present invention also includes a non-porous fiber-reinforced flat sheet film made in accordance with the following in-line steps: extruding plastic through a die to create a heated plastic mass; delivering fiberglass strands to the heated plastic mass as the heated plastic mass exits the die; passing the heated plastic through a nip whereby the strands laminate to the plastic to form the non-porous fiber-reinforced flat sheet film. Reinforced molded articles can be made using the non-porous film.

### BRIEF DESCIPTION OF THE DRAWINGS

FIG. 1 is a schematic representation showing an apparatus for the novel production process that may be used to produce the composite typical of the present invention.

FIG. 2 is a perspective view of the composite according to the present invention.

FIG. 3 is a schematic representation showing an apparatus for the novel production process used to produce the composite including a non-woven scrim according to the present invention.

FIG. 4 is a perspective view of the composite including a non-woven scrim according to the present invention.

### DETAILED DESCRIPTION OF THE PREFERRED EMBODIMENTS

This invention relates to laminating chopped fiberglass strands to plastic, and particularly to the process of laminating chopped fiberglass to a molten plastic film to form a non-porous extrudate. The extrudate is highly adherent to polyurethane foam surfaces and improves the strength of the composite product and molded articles.

The extrudate having fiberglass laminated to a plastic layer made according to this invention includes extruding plastic through a die to create a heated mass of plastic, delivering fiberglass strands to a roll, the roll defining a nip, and passing the heated plastic through the nip, whereby the strands laminate to the plastic to form the extrudate. The nip is adjacent the heated plastic as the plastic flows from the die. Adhering of the fibers is completed “in-line” during the plastic extrusion/casting process. The plastic need not be cooled and/or reheated for lamination with the fiberglass. The fiberglass strands are delivered to the heated plastic mass as the heated plastic mass exits the die. The heated plastic flows from the die adjacent the nip roll where fiberglass is sprinkled. A scrim layer may be added to the side of the plastic sheet opposite the fiberglass if desired for a particular application.

Suitable materials for use with the invention include synthetic or natural resins and polymers that can be extruded. The term “plastic” as used herein includes all such materials. Preferably the process includes extruding a blend of low-density polyethylene and a polyethylene copolymer through an extruder and a sheet/film die. The flow profile of the die is preferably a modified coat hanger design. A suitable copolymer for use in a subsequent urethane composite processing may included, for example only and not as a limitation of the invention, a polyethylene copolymer comprising about 6.5% Acrylic acid and 6.5% Methyl acrylate. The plastic may preferably comprise equal quantities of the polyethylene and of the copolymer by weight.

Plastic may be extruded in common fashion. An extruder such as a 4.5 inch diameter modified barrier screw with a 24:1 L/D (length/diameter ratio) may be used. A cylindrical screen pack filters the melted plastic. The head pressure and melt temperature are measured at the exit from the barrel of the extruder before the melt enters the adaptor and the screen changer. As the heated plastic flows out through the die, it passes through a set of chill rolls. The chill rolls preferably consist of one rubber roll and one steel roll. The chill rolls form a nip and this nip is held closed under pressure. When the heated plastic passes through the nip, the plastic is cooled and forms a sheet/film. The fiberglass is introduced to the plastic as the plastic exits the die. The fiberglass is laminated to the plastic as the plastic passes through the nip. Chopped fiberglass strands sprinkled on the chill roll laminate to the plastic.

The strands are chopped using a chopper. The chopper is mounted such that a chute delivering the chopped fiberglass into the nip area is approximately three to six inches away from the nip. Such distance can be adjusted by moving either the rolls or the chute. A continuous strand roving with a yield of 113 yards per pound, for example, is fed into the chopper.

Now a working example of this invention will be described below with reference to the accompanying drawings.

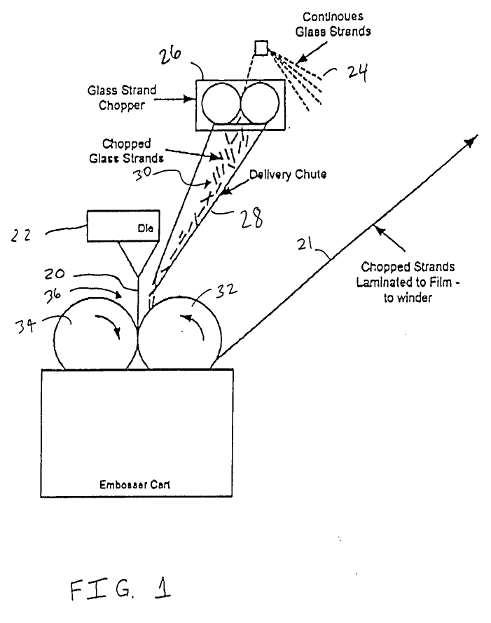

As shown in FIG. 1, plastic 20 is extruded from die 22 in common fashion (extruder not shown). Plastic 20 is a molten plastic mass as it exits die 22 and has no particularly defined form or dimension. Glass strands 24 are chopped into chopped glass strands 30 by chopper 26. Chopped strands 30 are delivered to delivery chute 28. Strands 30 are then delivered to roller 32. Roller 32 and adjacent roller 34 form a nip 36. Plastic 20 is delivered to nip 36. Strands 30 are delivered to nip 36 to simultaneously join with plastic 20, thereby creating an extrudate 21 (actually a composite) of flat sheet plastic film joined with laminated strands. The resulting composite is non-porous. Rollers 32 and 34 rotate in the directions shown in FIG. 1. The rate of delivery, size, and amount of dispersion of strands 30 may be varied according to desired preference and needs. The positioning of chute 28 may also be varied according to preference and needs, however chute 28 should be positioned to deliver strands 30 to a roller positioned adjacent plastic 20 as plastic 20 flows from die 22. Preferably, roller 32 is a common chill roller. While roller 32 may be made as is common, it is preferably made of steel and may include an impression so as to impart a design (not shown) on the extrudate. As plastic 20 comes in contact with roll 32, strands 30 are transferred from roll 32 to plastic 20. Strands 30 are laminated to plastic 20 without use of adhesives.

The strands 30 produced by chopper 26 are preferably between about 1.5 to 3.5 inches in length, and preferably about 2 inches. The desired dispersion and density of the chopped strands 30 on the surface of plastic 20 may be controlled by the feed placement of the continuous strands 24 into chopper 26 and by controlling the speed of chopper 26.

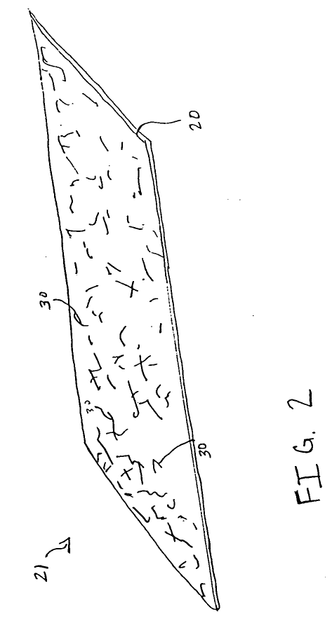

FIG. 2 shows the extrudate 21 or composite of FIG. 1 having chopped fiberglass strands 30 laminated to plastic layer 20. Strands 30 are embedded within plastic layer 20 at a top side of layer 20 as shown. In some instances some of the strands 30 may have a loose end. Preferably, none of the strands 30 are exposed or poke through at the bottom side (not shown) of layer 20. Extrudate 21 may be further processed for use in a desired application, it may be advanced to a sizing station where conventional cutting devices would size the extrudate to predetermined dimensions, and it may be rolled for transport or storage.

The following Table I includes the Heats and Setup profile of one example of product/method made in accordance with the present invention:

TABLE 1

| | Temp (Fahrenheit) |
|---|---|
| Extruder Barrel Heat Zones | |
| Zone 1: | 300 |
| Zone 2: | 325 |
| Zone 3: | 350 |
| Zone 4: | 350 |
| Zone 5: | 350 |
| Changer: | 350 |
| Pipe: | 350 |
| Block: | 350 |
| Die Heat Zones: | |
| Zone 1: | 365 |
| Zone 2: | 350 |
| Zone 3: | 350 |
| Zone 4: | 350 |
| Zone 5: | 350 |
| Zone 6: | 350 |
| Zone 7 | 365 |
| Wiper Roll: | Closed |
| Water Pan Temp. | 70 |
| Steel Roll Temp. | 70 |
| Wind: | |
| Tension PLI/mil: | 15 |
| Tension Taper: | 30 |
| Layon PLI/mil: | 60 |
| Layon Taper: | 20 |
| Extruder speed: | 60 rpm |
| Run: | 143 feet/min |

Run with the wiper roll open at the start, thin the edges, then close wiper roll to reduce sticking on rubber roll. Deliver fiberglass on film at 40 gm/sq meter.

A further working example of a non-porous aspect of the invention is described with reference to the drawings.

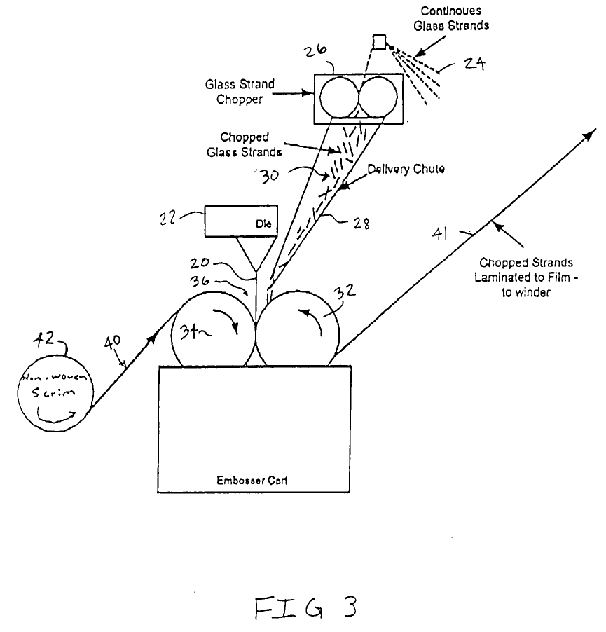

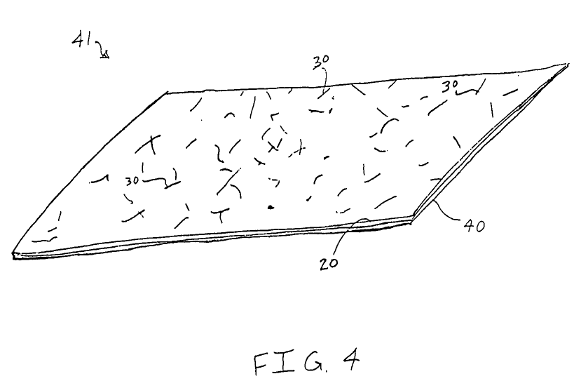

FIG. 3 is similar in content as FIG. 1 and further includes use of a non-woven scrim 40 supplied from a scrim roll 42. Scrim 40 adheres to plastic 20 when scrim 40 and plastic 20 simultaneously pass nip 36. FIG. 4 shows the extrudate 41 or composite of FIG. 3 having chopped fiberglass strands 30 laminated to plastic 20 at a top side of layer 20, with scrim 40 laminated at a bottom side of plastic 20.

The following Table 2 includes the Heats and Setup profile of another example of product/method made in accordance with the present invention:

TABLE 2

| | Temp (Fahrenheit) |
|---|---|
| Extruder Barrel Heat Zones | |
| Zone 1: | 300 |
| Zone 2: | 325 |
| Zone 3: | 350 |
| Zone 4: | 350 |
| Zone 5: | 350 |
| Changer: | 350 |
| Pipe: | 350 |
| Block: | 350 |
| Die Heat Zones: | |
| Zone 1: | 350 |
| Zone 2: | 350 |
| Zone 3: | 350 |
| Zone 4: | 350 |
| Zone 5: | 350 |
| Zone 6: | 350 |
| Zone 7 | 350 |
| Wiper Roll: | Closed |
| Water Pan Temp. | 70 |
| Steel Roll Temp. | 70 |
| Wind: | |
| Tension PLI/mil: | 15 |
| Tension Taper: | 30 |
| Layon PLI/mil: | 60 |
| Layon Taper: | 20 |
| Extruder speed: | 60 rpm |
| Run: | 143 feet/min |

Laminate 0.5 oz non-woven PET scrim and 40 grams/sq. meter fiberglass strands to film.

The descriptions above and the accompanying drawings should be interpreted in the illustrative and not the limited sense. For instance, the invention encompasses fiber reinforced molded articles which include a non-porous fiber-reinforced flat sheet film formed by the process described above. Such molded articles may be manufactured under a variety of methods, including methods which incorporate the film made in accordance with the present invention. While the invention has been disclosed in connection with embodiments thereof, it should be understood that there may be other embodiments which fall within the scope of the invention as defined by the following claims. Where a claim is expressed as a means or step for performing a specified function it is intended that such claim be construed to cover the corresponding structure, material, or acts described in the specification and equivalents thereof, including both structural equivalents and equivalent structures.

1. A composite having fiberglass laminated to a plastic layer, said composite made in accordance with the following steps:
extruding plastic through a die to create a heated plastic mass;
delivering fiberglass strands to a roll, the roll defining a nip;
passing said heated plastic through the nip whereby said strands laminate to said plastic to form said composite.

2. The composite according to claim 1 wherein said strands are chopped from continuous glass strands.

3. The composite according to claim 1 wherein said strands are delivered from a chute.

4. The composite according to claim 3 wherein the chute is positioned above the nip.

5. The composite according to claim 3 wherein the chute is positioned to deliver strands to the roll, the roll positioned adjacent said plastic as said plastic flows from the die.

6. The composite according to claim 1 wherein said strands are sprinkled on the roll.

7. The composite according to claim 1 wherein the roll is a steel chill roll.

8. The composite according to claim 1 wherein the nip is defined by two rolls wherein one of the rolls is a rubber roll.

9. The composite according to claim 1 wherein a non-woven scrim is passed through the nip.

10. The composite according to claim 9 wherein said non-woven scrim is passed through the nip opposite said strands.

11. The composite according to claim 1 wherein said extrudate is a non-porous flat sheet film.

12. The composite according to claim 1 wherein said steps are completed in-line.

13. The process of manufacturing a composite having fiberglass laminated to a plastic layer, the process comprising the following steps:
extruding plastic through a die to create a heated plastic mass;
delivering fiberglass strands to a roll, the roll defining a nip;
passing the heated plastic through the nip whereby the strands laminate to the plastic to form the composite.

14. The process according to claim 13 wherein said process is completed in-line.

15. A fiber reinforced molded article including a non-porous flat sheet film composite formed by the process of claim 13.

16. A non-porous fiber-reinforced flat sheet film made in accordance with the following in-line steps:
extruding plastic through a die to create a heated plastic mass;
delivering fiberglass strands to a roll, the roll defining a nip;
passing said heated plastic through the nip whereby said strands laminate to said plastic to form said non-porous fiber-reinforced flat sheet film.

17. The film according to claim 16 wherein said plastic includes a blend having substantially equal quantities by weight of a low-density polyethylene and of a polyethylene copolymer.

18. The film according to claim 17 wherein the polyethylene copolymer comprises about 6.5% acrylic acid and about 6.5% methyl acrylate.

19. The process of in-line manufacturing a non-porous fiber-reinforced flat sheet film comprising the following steps:
extruding plastic through a die to create a heated plastic mass;
delivering fiberglass strands to a roll, the roll defining a nip;
passing said heated plastic through the nip whereby said strands laminate to said plastic to form said non-porous fiber-reinforced flat sheet film.

20. A fiber reinforced molded article including a non-porous fiber-reinforced flat sheet film formed by the process of claim 19.

21. A composite having fiberglass strands and a non-woven scrim laminated to a plastic layer, said composite made in accordance with the following steps:
extruding plastic through an extruder and a die to create a heated extrudate;
passing said heated extrudate through a chill roll forming a nip;
sprinkling fiberglass strands on the chill roll whereby said fiberglass is laminated on a first side of said heated extrudate;
laminating a non-woven scrim to a second side of said heated extrudate;
cooling said extrudate into a composite; and
winding said composite on a roll.

22. The process of manufacturing a composite having a first layer of plastic, a second layer of non-woven scrim laminated to the first layer, and fiberglass strands joined to the first layer opposite the second layer, the process comprising the following steps:
extruding plastic through an extruder and die to create a heated extrudate;
passing the heated extrudate through a set of chill rolls forming a nip;
sprinkling fiberglass strands on a steel chill roll;
laminating said fiberglass strands on a first side of the heated extrudate;
laminating a non-woven scrim to a second side of the heated extrudate;
cooling the extrudate into a composite; and
winding the composite on a roll.

23. A non-porous fiber-reinforced flat sheet film made in accordance with the following in-line steps:
extruding plastic through a die to create a heated plastic mass;
delivering fiberglass strands to said heated plastic mass as said heated plastic mass exits the die;
passing said heated plastic through a nip whereby said strands laminate to said plastic to form said non-porous fiber-reinforced flat sheet film.
